(19) United States
(12) Patent Application Publication
(10) Pub. No.: US 2026/0261343 A1
(43) Pub. Date: Sep. 3, 2026

(54) ENHANCED OPTICAL LINE TERMINAL (OLT) WITH LAYER 3 FUNCTIONALITY

(71) Applicant: Level 3 Communications, LLC, Denver, CO (US)

(72) Inventor: Ryan M. Traum, Salt Lake City, UT (US)

(73) Assignee: Level 3 Communications, LLC, Denver, CO (US)

(21) Appl. No.: 19/374,431

(22) Filed: Oct. 30, 2025

Related U.S. Application Data
(60) Provisional application No. 63/764,745, filed on Feb. 28, 2025.

(51) Int. Cl. H04B 10/27; H04B 10/079; H04L 43/04

(52) U.S. Cl. CPC H04B 10/27; H04B 10/0793; H04L 43/04

(57) ABSTRACT

Novel tools and techniques are provided for implementing an enhanced optical line terminal ("OLT") with Layer 3 functionality. In examples, a computing system, which is located within a network of a service provider, receives a request for an Internet protocol ("IP") address from an OLT. The computing system assigns a first IP address to the OLT, from a list of IP addresses reserved for assignment to customer premises equipment ("CPE") to be connected to the network. The computing system sends at least one test packet to the OLT over a path through the network, based on the first IP address, the path including network nodes that transport data traffic over Layer 3 of the network. The computing system receives a response to the at least one test packet from the OLT, measures network characteristics based on the response, and sends the network characteristics to a device.

### CROSS-REFERENCE TO RELATED APPLICATIONS

This application claims the benefit of U.S. Provisional Application No. 63/764,745 filed February 28, 2025, entitled "Enhanced Optical Line Terminal (OLT) with Layer 3 Functionality," which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing enhanced optical line terminal ("OLT") with Layer 3 functionality.

### BACKGROUND

Although conventional OLTs provide service provider network access to optical network terminals ("ONTs") and residential gateways ("RGs") via a passive optical network ("PON"), conventional OLTs lack the capability of connecting with network equipment in the service provider network to authenticate via a broadband network gateway ("BNG") and obtain a Layer 3 data path that would mirror a data path used by a subscriber via the ONTs and RGs to exchange data. As such, performance, functionality, and operationality of conventional OLTs or the Layer 3 data path cannot be performed without connecting either an ONT and an RG to test using the connected ONT and RG. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing an enhanced OLT with Layer 3 functionality, in accordance with various embodiments.

FIG. 2 depicts an example system illustrating communication exchange between a computing system(s) and an OLT when implementing an enhanced OLT with Layer 3 functionality, in accordance with various embodiments.

FIG. 3 depicts a flow diagram illustrating a method for implementing an enhanced OLT with Layer 3 functionality, in accordance with various embodiments.

FIG. 4 depicts a flow diagram illustrating another method for implementing an enhanced OLT with Layer 3 functionality, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In examples, a computing system (e.g., BNG, server, etc.), which is located within a network of a service provider, receives a request for an IP address from an OLT. The computing system (e.g., BNG) assigns a first IP address to the OLT, from a list of IP addresses reserved for assignment to customer premises equipment ("CPE"; including ONTs and RGs) to be connected to the network. The computing system (e.g., server) sends at least one test packet to the OLT over a path through the network, based on the first IP address, the path including network nodes that transport data traffic over Layer 3 of the network. The computing system receives a response to the at least one test packet from the OLT, measures network characteristics based on the response, and sends the network characteristics to a device.

As used herein, Layer 3 refers to the open systems interconnection ("OSI") model's network layer, which is responsible for packet forwarding including routing through intermediate routes. Internet protocol ("IP") network layer communications protocol (e.g., IP version 4 ("IPv4") or IP version 6 ("IPv6"), etc.) is used over Layer 3 to relay data packets or datagrams across network boundaries. A datagram, as used herein, refers to a basic transfer unit associated with a packet-switched network, and typically has a structure including header and payload sections.

These and other aspects of the enhanced OLT with Layer 3 functionality are described in greater detail with respect to the figures. In the manner above, Layer 3 functionality provided to the enhanced OLT from the assigned IP address allows network performance to be performed between the OLT and the computing system, even without an ONT and an RG or a combination ONT/RG being communicatively coupled to the OLT to test or measure network characteristics of the Layer 3 path between the computing system and the OLT. In some cases, the enhanced OLT, with the assigned IP address, may function like an ONT and an RG or a combination ONT/RG in terms of communicatively coupling with the computing system over the Layer 3 path in the network and in terms of being accessible directly based on the assigned IP address.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a computing system located within a network of a service provider and from an OLT of a PON, a request for an IP address; assigning, by the computing system, a first IP address to the OLT, the first IP address being assigned from a list of IP addresses reserved for assignment to CPE to be connected to the network; sending, by the computing system, an indication of the first IP address to the OLT; sending, by the computing system, at least one test packet to the OLT over a path through the network, based on the first IP address, the path including network nodes in the network that transport data traffic over Layer 3 of the network; receiving, by the computing system, a response to the at least one test packet from the OLT; measuring, by the computing system, one or more network characteristics, based on the response; and sending, by the computing system, the one or more network characteristics to a device.

In another aspect, the technology relates to a system, including a computing system located within a network of a service provider and memory coupled to the computing system, the memory including computer executable instructions that, when executed by the computing system, causes the computing system to perform operations. The operations include receiving a request for an IP address from an OLT of a PON; assigning a first IP address to the OLT, the first IP address being assigned from a list of IP addresses reserved for assignment to CPE to be connected to the network; sending an indication of the first IP address to the OLT; sending at least one test packet to the OLT over a path through the network, based on the first IP address, the path including network nodes in the network that transport data traffic over Layer 3 of the network; receiving a response to the at least one test packet from the OLT; measuring one or more network characteristics, based on the response; and sending the one or more network characteristics to a device.

In yet another aspect, the technology relates to a OLT of a PON, the OLT including a processing system and memory coupled to the processing system, the memory including computer executable instructions that, when executed by the processing system, causes the OLT to perform operations. The operations include sending a request for an IP address to a broadband network gateway, via dynamic host configuration protocol ("DHCP"); receiving, from the broadband network gateway, an indication of an assignment of a first IP address for the OLT, the first IP address being assigned from a list of IP addresses reserved for assignment to CPE to be connected to a network of a service provider; and exchanging data packets with a computing system that is located within the network of the service provider over a path through the network between the computing system and the OLT that is created based on the first IP address, the path including network nodes in the network that transport the data packets over Layer 3 of the network.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

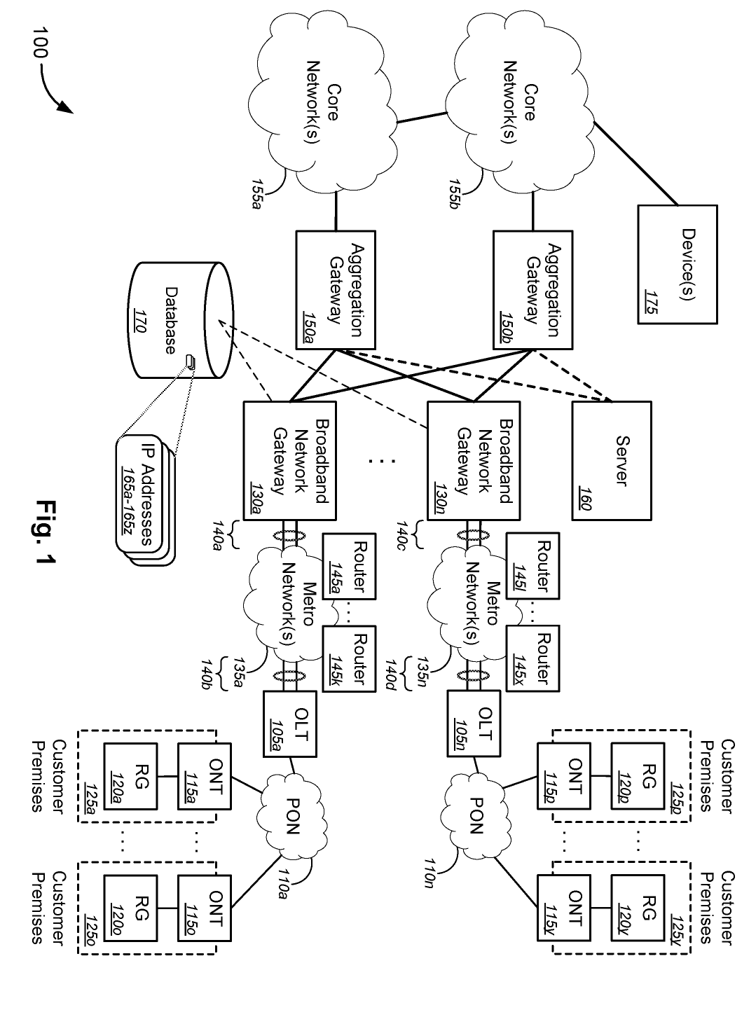

Turning to the embodiments as illustrated by the drawings, FIGS. 1-5 illustrate some of the features of methods, systems, and apparatuses for implementing an enhanced OLT with Layer 3 functionality, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing an enhanced OLT with Layer 3 functionality, in accordance with various embodiments.

In examples, system 100 may include a plurality of OLTs 105a-105n (collectively, "OLTs 105" or the like), a plurality of PONs 110a-110n (collectively, "PONs 110" or the like), a plurality of ONTs 115a-115o and 115p-115y (collectively, "ONTs 115" or the like), and RGs 120a-120o and 120p-120y (collectively, "RGs 120" or the like). In some cases, each set of ONTs 115a-115o and 115p-115y and corresponding RGs 120a-120o and 120p-120y is disposed or located at customer premises 125a-125o and 125p-125y (collectively, "customer premises 125" or the like). That is, ONT 115a and RG 120a are disposed or located at customer premises 125a, while ONT 115o and RG 120o are disposed or located at customer premises 125o, and ONT 115p and RG 120p are disposed or located at customer premises 125p, and so on.

In some cases, customer premises 125a-125o and 125p-125y may each include, but is not limited to, one of a residential customer premises, a business customer premises, a corporate customer premises, an enterprise customer premises, an education facility customer premises, a medical facility customer premises, or a governmental customer premises, and/or the like. In some instances, customers or users associated with the customer premises 125a-125o and 125p-125y, and/or associated with corresponding ones of the ONTs 115a-115o and 115p-115y and/or RGs 120a-120o and 120p-120y, may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

System 100 may further include a plurality of broadband network gateways 130a-130n (collectively, "broadband network gateways 130" or the like), a plurality of metro networks 135a-135n (collectively, "metro networks 135" or the like), a plurality of link aggregation groups ("LAGs") 140a-140d (collectively, "LAGs 140" or the like; each LAG being denoted by parallel lines bundled by a ring shape), and a plurality of routers 145a-145k and 145l-145x (collectively, "routers 145" or the like). System 100 may further include a pair of aggregation gateways 150a and 150b (collectively, "aggregation gateways 150" or the like), core networks 155a and 155b (collectively, "core networks 155" or the like), and server 160. In examples, a list of IP addresses 165a-165z (collectively, "IP addresses 165" or the like) that are reserved for allocation or assignment to CPE (e.g., ONTs 115a-115o and 115p-115y and/or RGs 120a-120o and 120p-120y, and/or the like) may be stored in a database 170. Herein, k, l, n, o, p, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). In some examples, system 100 may further include device(s) 175, which may each include, but is not limited to, one of includes one of a console of a network operations center ("NOC"), a technician device associated with a field technician, an agent device associated with an agent of the service provider, or a user device associated with a customer of the service provider who is associated with a CPE with which the OLT is communicatively coupled over the PON, and/or the like. In some instances, the user device may include one of a desktop computer, a laptop computer, a tablet computer, a smart phone, a mobile phone, or any suitable user device, or the like.

In examples, each PON 110 is a fiber-optic telecommunications network that uses unpowered devices to carry optical signals, and is typically used for the last mile between the customer premises 125 and the service provider network(s) (in this case, metro network(s) 135a-135n, core network(s) 155a and 155b, and components therein (including broadband network gateways 130a-130n, routers 145a-145k or 145l-145x, aggregation gateways 150a and 150b, server 160, database 170, and/or the like). Each OLT 105 of a corresponding one of the PONs 110a-110n communicatively couples with a plurality of ONTs 115a-115o or a plurality of ONTs 115p-115y, and corresponding customer premises 125a-125o or customer premises 125p-125y. Each ONT 115a-115o or 115p-115y communicatively couples with a corresponding one of the RGs 120a-120o and 120p-120y. Each of OLTs 105a-105n communicatively couples with a corresponding one of broadband network gateways 130a-130n via corresponding one of metro networks 135a-135n via corresponding ones of LAGs 140a-140d and/or corresponding one or more of routers 145a-145k or 145l-145x. Each OLT 105 is configured to provide first optical data signals for transmission over the corresponding PON 110 to a plurality of ONTs 115 located at customer premises 125 serviced by that PON 110, and configured to relay second optical data signals from the plurality of ONTs 115 to the service provider network(s) or to convert the second optical data signals into first electrical data signals for transmission to the service provider network(s). Each ONT 115 is configured to convert the first optical data signals into second electrical data signals that are received by a corresponding RG 120 for communication with devices (in some cases, via radio transmission using communication protocols such as Bluetooth^{TM}, Wi-Fi, etc.) within the corresponding customer premises 125 that are communicatively coupled with that RG 120, and configured to convert third electrical data signals received from the corresponding RG 120 (which relays data signals transmitted to it from those devices via electrical transmission or via radio transmission) into the second optical data signals for transmission to a corresponding OLT 105 via the corresponding PON 110.

Each one of broadband network gateways 130a-130n communicatively couples with each of aggregation gateways 150a and 150b. Each of aggregation gateways 150a and 150b communicatively couples with a corresponding one of core networks 155a or 155b, with server 160, and with database 170. A set of aggregation gateway 150a or 150b and core network(s) 155a or 155b provides parallel redundancy. Since each aggregation gateway 150a and 150b is communicatively coupled to each of the plurality of broadband network gateways 130a-130n, load balancing, failover, and/or maintenance (with one set taking over network operations while the other set is taken offline for maintenance) can be achieved. According to some embodiments, unless otherwise indicated, network(s) 135a-135n and 155a-155b may each include, without limitation, one of a local area network ("LAN"), including, without limitation, a fiber network, an Ethernet network, a Token-Ring™ network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, unless otherwise indicated, the network(s) 135a-135n and 155a-155bmay include an access network of the service provider (e.g., an Internet service provider ("ISP")). In another embodiment, unless otherwise indicated, the network(s) 135a-135n and 155a-155b may include a core network of the service provider and/or the Internet.

In some aspects, an OLT 105 sends a request for an IP address to a corresponding broadband network gateway 130, in some cases, via DHCP (and the request is a DHCP request), which is a network protocol that is used to assign IP addresses to devices on a network. Referring to FIG. 1, OLT 105a sends a request for an IP address to broadband network gateway 130a, while OLT 105b sends a request for an IP address to broadband network gateway 130b, and, so on through, OLT 105n sending a request for an IP address to broadband network gateway 130n. In response to receiving the request, the corresponding broadband network gateway 130 authenticates the OLT 105, and assigns a first IP address (from among the IP addresses 165a-165z that are reserved for allocation or assignment to ONTs 115 and/or RGs 120, or other CPE). In some cases, the broadband network gateway 130 may send an indication of the first IP address to the OLT 105, either (i) via metro network(s) 135, LAGs 140, and routers 145, (ii) via a management IP route (which is separate from the metro network(s) 135) to a management IP address of the OLT 105, or (iii) via other communications routes (such as those involving cellular network communications, etc.). As used herein, the management IP address of the OLT 105 is separate from the IP address that is assigned by the broadband network gateway 130, as the former is for exchanging management data over a separate management IP route, while the latter is for exchanging data packets over the same Layer 3 network over which data traffic is transmitted between the service provider network(s) and the CPE in customer premises 125 via corresponding OLT 105 and corresponding PON 110.

The broadband network gateway 130, the aggregation gateway 150a or 150b, and/or the server 160 (collectively, "computing system") may send at least one test packet to the OLT 105 over a path through the network, based on the first IP address, the path including network nodes (e.g., the routers 145a-145kor 145l-145x, or the like) in the network (e.g., metro network(s) 135a-135n, or the like) that transport the at least one test packet over Layer 3 of the network. That is, the first IP address is used as the destination for sending the at least one test packet over a Layer 3 virtual circuit that ultimately forms the path from one network node to another between the computing system and the OLT 105. In examples, the path through the network includes a plurality of alternative paths that are randomly selected using hashing of values in packet headers of data packets being transmitted between the computing system and the OLT, the plurality of alternative paths corresponding to one (or more) of the LAGs 140a-140dof the network. The computing system receives a response to the at least one test packet from the OLT, and measures one or more network characteristics, based on the response. The computing system may send the one or more network characteristics, a summary of the one or more network characteristics, and/or an analysis of the one or more network characteristics to the device(s) 175.

In some examples, the one or more network characteristics include at least one of latency, packet loss, jitter, bandwidth, network speed, connectivity, or network performance, and/or the like. Latency corresponds to a time over which the at least one test packet is transmitted to and/or from the OLT from and/or to the computing system, where high latency (e.g., latency greater than 60 milliseconds (ms)) may be indicative of a long distance path between the computing system and the OLT, network congestion issues, and/or network transmission medium issues, and/or the like. Packet loss corresponds to number of data packets among the at least one test packet is lost (i.e., not received) during the exchange between the computing system and the OLT, where packet loss may be indicative of network congestion, aging hardware, software issues, etc. Jitter corresponds to a variation in time delay between when the at least one test packet is sent and when the at least one test packet is received over the network, where bad jitter values (e.g., greater than 50 ms) may be indicative of network congestion, poor hardware performance, routing issues, etc. Bandwidth corresponds to a maximum amount of data that can be transferred over the network in a given amount of time.

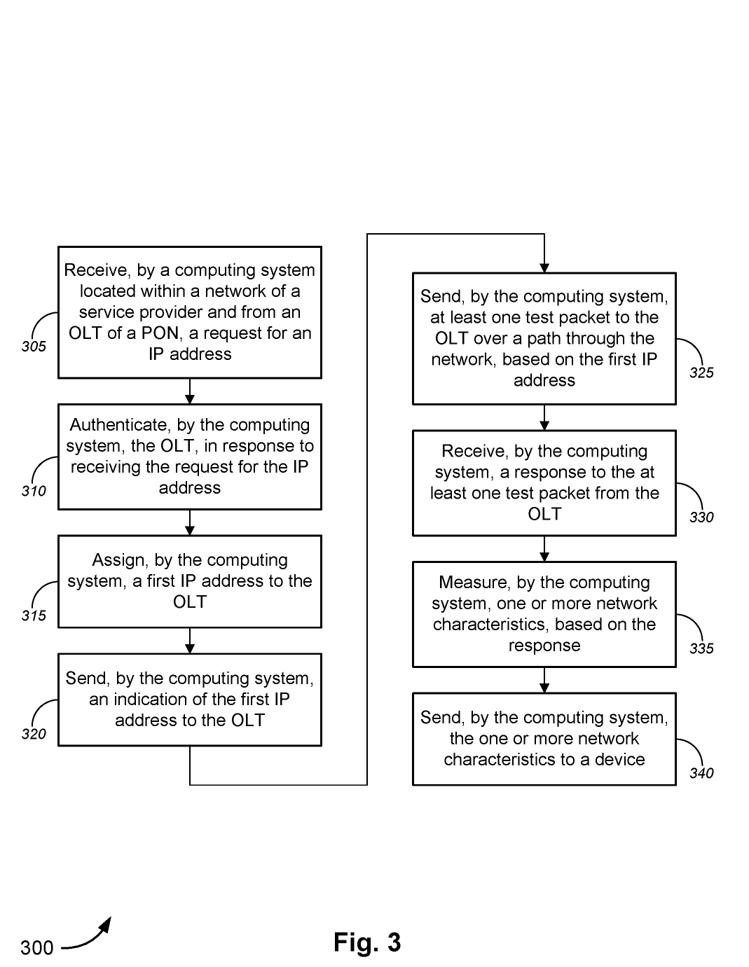

Network speed (or data transfer rate) corresponds to a rate at which data packets are transferred between two devices on the network (in this case, the rate at which the at least one test packet is transmitter to and/or from the OLT from and/or to the computing system). Connectivity (as used herein) corresponds to whether the OLT is connected to the network (e.g., over the Layer 3 path), in some cases, with a connectivity map or connectivity report being generated that tracks network nodes along the path through the network (e.g., as described in detail below with respect to FIG. 3). In some examples, the connectivity map or connectivity report may be generated based on Internet control message protocol ("ICMP") packets that are sent along a path between the computing system and the OLT and based on ICMP timestamps for each router along the path (e.g., as described in detail below with respect to FIG. 3). A network speed test may be performed to measure the network speed between the computing system (in some cases, server 160, or the like) and the OLT. In some cases, the OLT may be one of modified from an existing OLT device, rebuilt from an existing OLT device, or a new OLT that is designed from the outset to include a dedicated chipset that is tasked with initiating the network speed test, specifically to transfer data packets of a particular size (e.g., data packets cumulatively totaling 1400 bytes up to 200 megabytes (MB), or up to 1 GB, or greater) at high network speeds (e.g., greater than 100 megabits per second (Mbps), in some cases up to 1 gigabit per second (Gbps), or greater). In some instances, the dedicated chipset is further configured to support entropy (e.g., randomness in routing the test packets through the network, or the like), and, in some cases, to support options to customize features including transmission control protocol ("TCP") functionalities, user datagram protocol ("UDP") functionalities, functionalities of other protocols, port selection, thread selection, and/or the like.

Network performance corresponds to quality and effectiveness of a network system, which is indicative of its speed, reliability, and efficiency. Network performance can be measured based on simple two-way active measurement protocol ("STAMP"), two-way active measurement protocol ("TWAMP"), and/or implementation of performance measurement and tuning, using a cross-platform tool (such as iPerf). In examples, cross-platform tools (like iPerf) either (A) measures a throughput of a payload that is sent over the path over TCP, and provides payload throughput measurement results, or (B) measures a throughput of a datagram that is sent over the path over UDP, and providing datagram throughput measurement results and packet loss results.

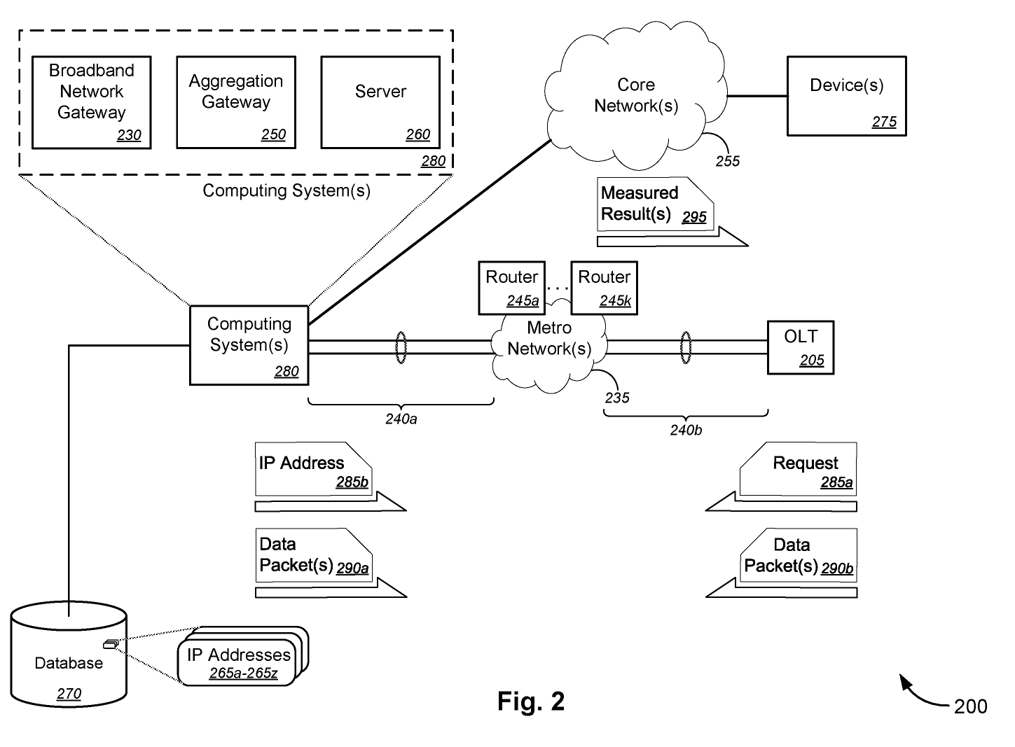

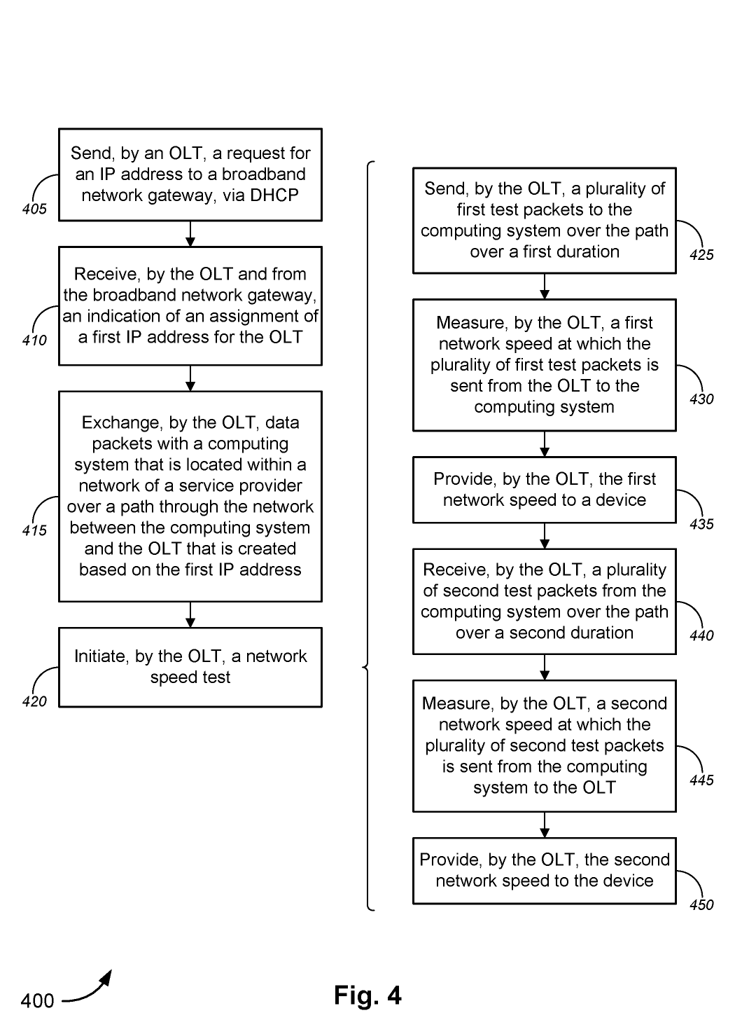

These and other functionalities of the system 100 particularly with respect to OLTs 105 are described in detail below with respect to FIGS. 2-4. In operation, the computing system (e.g., one of the broadband network gateways 130, one of the aggregation gateway 150aor 150b, and/or the server 160, and/or the like) and/or one of the OLTs 105 may perform methods for implementing an enhanced OLT with Layer 3 functionality, as described in detail with respect to FIGS. 2-4. For example, communication exchanges as described below with respect to FIG. 2, example methods 300 and 400 as described below with respect to FIGS. 3 and 4, respectively, may be applied with respect to the operations of system 100 of FIG. 1.

FIG. 2 depicts an example system 200 illustrating communication exchange between a computing system(s) and an OLT when implementing an enhanced OLT with Layer 3 functionality, in accordance with various embodiments. In some embodiments, OLT 205, broadband network gateway 230, metro network(s) 235, LAGs 240a and 240b, routers 245a-245k, aggregation gateway 250, server 260, and device(s) 275 of FIG. 2 may be similar, if not identical, to the OLTs 105a-105n, broadband network gateways 130a-130n, metro networks 135a-135n, LAGs 140a-140d, routers 145a-145kand 145l-145x, aggregation gateways 150a and 150b, server 160, and device(s) 175, respectively, of system 100 of FIG. 1, and the description of these components of system 100 of FIG. 1 are similarly applicable to the corresponding components of FIG. 2.

With reference to FIG. 2, example system 200 includes OLT 205, metro network(s) 235, LAGs 240a and 240b, routers 245a-245k, computing system(s) 280, core network(s) 255, database 270, and device(s) 275. In examples, the computing system(s) 280 may include one of a server (e.g., server 260, or the like), a router (e.g., one of routers 245a-245k, or the like), a broadband network gateway (e.g., broadband network gateway 230, or the like), an aggregation gateway (e.g., aggregation gateway 250, or the like), or an orchestrator, and/or the like. OLT 205 communicatively couples with computing system(s) 280 via metro network(s) 235, LAGs 240aand 240b, and/or routers 245a-245k.

In operation, OLT 205 sends a request 285a for an IP address to computing system(s) 280, in some cases, via DHCP (as described above with respect to FIG. 1). In some cases, OLT 205 sends the request 285a for an IP address to broadband network gateway 230. In response to receiving the request 285a, the computing system(s) 280 (in some cases, broadband network gateway 230, or the like) authenticates the OLT 205, and assigns a first IP address (from among the IP addresses 265a-265z (stored in database 270) that are reserved for allocation or assignment to CPE (e.g., ONTs 115 and/or RGs 120, or other CPE of FIG. 1, or the like)). In some cases, the computing system(s) 280 (in some cases, broadband network gateway 230) may send the first IP address or an indication of the first IP address 285b to the OLT 205, either (i) via metro network(s) 235, LAGs 240a and 240b, and routers 245a-245k, (ii) via a management IP route (which is separate from the metro network(s) 235) to a management IP address of the OLT 205, or (iii) via other communications routes (such as those involving cellular network communications, etc.).

In examples, the computing system(s) 280 (in some cases, the server 260, or the like) may send at least one test packet (e.g., data packet(s) 290a, or the like) to the OLT 205 over a path through the network (e.g., metro network(s) 235, or the like), based on the first IP address 285b, the path including network nodes (e.g., the routers 245a-245k, or the like) in the network (e.g., metro network(s) 235, or the like) that transport the at least one test packet over Layer 3 of the network. That is, the first IP address 285bis used as the destination for sending the at least one test packet over a Layer 3 virtual circuit that ultimately forms the path from one network node to another between the computing system(s) 280 and the OLT 205. In examples, the path through the network includes a plurality of alternative paths that are randomly selected using hashing of values in packet headers of data packets (e.g., data packet(s) 290a) being transmitted between the computing system(s) 280 and the OLT 205, the plurality of alternative paths corresponding to one (or more) of the LAGs 240a and 240b of the network. The computing system(s) 280 (in some cases, the server 260, or the like) receives a response (e.g., data packet(s) 290b, or the like) to the at least one test packet (e.g., data packet(s) 290a, or the like) from the OLT 205, and measures one or more network characteristics, based on the response. The computing system(s) 280 (in some cases, the server 260, or the like) may send the one or more network characteristics, a summary of the one or more network characteristics, and/or an analysis of the one or more network characteristics (e.g., measured result(s) 295, or the like) to the device(s) 275 (in some cases, via core network(s) 255, or the like). The functionalities of the components of example system 200 of FIG. 2 (e.g., with respect to implementation of an enhanced OLT with Layer 3 functionality, and/or the like) may be otherwise similar, if not identical, to those of the corresponding components of example system 100 of FIG. 1, and the descriptions of those components of system 100 are applicable to the corresponding components of system 200.

FIG. 3 depicts a flow diagram illustrating a method 300 for implementing an enhanced OLT with Layer 3 functionality, in accordance with various embodiments. With reference to FIG. 3, the operations of example method 300 may be performed by a computing system(s) (e.g., computing system(s) 280 of FIG. 2, which may include broadband network gateways 130a-130nand 230, aggregation gateways 150a, 150b, and 250, and/or servers 160 and 260 of FIGS. 1 and 2, or the like).

In the example method 300 of FIG. 3, at operation 305, a computing system, which is located within a network of a service provider, receives a request for an IP address from an OLT (e.g., OLTs 105a-105nand 205 of FIGS. 1 and 2, or the like) of a PON (e.g., one of PONs 110a-110nof FIG. 1, or the like), in some cases, via DHCP (and the request is a DHCP request). At operation 310, the computing system authenticates the OLT, in response to receiving the request for the IP address, in some cases, based on at least one of verification of a shared secret key between the OLT and the computing system, verification of an identifier of the OLT (e.g., serial number, media access control ("MAC") address, assigned nickname, etc.), or messages from the OLT being allowed through a firewall of the network of the service provider, and/or the like. After authenticating the OLT, at operation 315, the computing system assigns a first IP address to the OLT, the first IP address being assigned from a list of IP addresses that are reserved for assignment (or allocation) to CPE to be connected to the network (e.g., ones of ONTs 115a-115oand 115p-115yand/or RGs 120a-120oand 120p-120yof FIG. 1 that have yet to be connected (or reconnected) to the network, or a combination ONT/RG (also referred to herein as a smart network interface device ("SmartNID"), or the like). In some cases, the first IP address is a static IP address, which is associated with the OLT until otherwise assigned or changed. In some examples, the computing system may send an indication of the first IP address to the OLT (at operation 320).

At operation 325, the computing system sends at least one test packet to the OLT over a path through the network, based on the first IP address, the path including network nodes in the network that transport data traffic over Layer 3 of the network. The computing system receives a response to the at least one test packet from the OLT (at operation 330). In examples, the computing system measures one or more network characteristics, based on the response (at operation 335), and sends the one or more network characteristics to a device (e.g., devices 175 and 275 of FIGS. 1 and 2, or the like) (at operation 340). In examples, the path through the network (e.g., between the computing system and the OLT) includes a plurality of alternative paths that are randomly selected using hashing of values in packet headers of data packets being transmitted between the computing system and the OLT, the plurality of alternative paths corresponding to a link aggregation group (e.g., LAG links 140a-140dor 240a-240bof FIGS. 1 and 2, or the like) of the network.

In some examples, the one or more network characteristics may include at least one of latency, packet loss, jitter, bandwidth, network speed, connectivity, or network performance, and/or the like. In an example, measuring the one or more network characteristics (at operation 325) includes mapping a connectivity of the path through the network (e.g., between the computing system and the OLT), by: (a) sending, by the computing system, an ICMP packet to the OLT over the path; (b) receiving, by the computing system, a response from each router along the path that routes the ICMP packet to the OLT, the response from each router including an ICMP timestamp that includes a date and time of that router; and (c) generating at least one of a connectivity map or a connectivity report based on the ICMP timestamp for each router. In some cases, the at least one of the connectivity map or the connectivity report may indicate (1) information regarding a number of routing hops along the path between the computing system and the OLT, (2) information regarding each router along the path, (3) information regarding whether each router is capable of transferring data, (4) information regarding packet latency along each routing hop, and (5) information regarding unresponsive or unreachable routers, and the like.

In another example, measuring the one or more network characteristics (at operation 325) includes performing network a performance measurement over the path through the network (e.g., between the computing system and the OLT), based on one of STAMP, TWAMP, a TCP-based echo service, or a UDP-based echo service. In yet another example, measuring the one or more network characteristics (at operation 325) includes implementing performance measurement and tuning, using a cross-platform tool, by performing one of: (A) measuring, by the computing system, a throughput of a payload that is sent over the path over TCP, and providing payload throughput measurement results; or (B) measuring, by the computing system, a throughput of a datagram that is sent over the path over UDP, and providing datagram throughput measurement results and packet loss results. In still another example, measuring the one or more network characteristics (at operation 325) includes performing a network speed test, by: (i) sending, by the computing system, a plurality of first test packets to the OLT over the path over a first duration, measuring a first network speed at which the plurality of first test packets is sent from the computing system to the OLT, and providing the first network speed to the device; and (ii) receiving, by the computing system, a plurality of second test packets from the OLT over the path over a second duration, measuring a second network speed at which the plurality of second test packets is sent from the OLT to the computing system, and providing the second network speed to the device.

FIG. 4 depicts a flow diagram illustrating another method 400 for implementing an enhanced OLT with Layer 3 functionality, in accordance with various embodiments. Referring to FIG. 4, the operations of example method 400 may be performed by an OLT (e.g., OLTs 105a-105n and 205 of FIGS. 1 and 2, or the like).

In the example method 400 of FIG. 4, at operation 405, an OLT sends a request for an IP address to a broadband network gateway (e.g., broadband network gateways 130a-130nand 230 of FIGS. 1 and 2, or the like), in some cases, via DHCP (and the request is a DHCP request). At operation 410, the OLT receives an indication of an assignment of a first IP address for the OLT, the first IP address being assigned from a list of IP addresses reserved for allocation or assignment to CPE to be connected to a network of a service provider (e.g., ones of ONTs 115a-115oand 115p-115yand/or RGs 120a-120o and 120p-120yof FIG. 1 that have yet to be connected (or reconnected) to the network, or a combination ONT/RG (or a SmartNID), or the like). In some cases, the first IP address is a static IP address, which is associated with the OLT until otherwise assigned or changed. In examples, the OLT, at operation 415, exchanges data packets with a computing system that is located within a network of a service provider over a path through the network between the computing system and the OLT that is created based on the first IP address, the path including network nodes in the network that transport the data packets over Layer 3 of the network. At operation 420, the OLT initiates a network speed test, by (1) sending a plurality of first test packets to the computing system over the path over a first duration (at operation 425); (2) measuring a first network speed at which the plurality of first test packets is sent from the OLT to the computing system (at operation 430); (3) providing the first network speed to a device (at operation 435); (4) receiving a plurality of second test packets from the computing system over the path over a second duration (at operation 440); (5) measuring a second network speed at which the plurality of second test packets is sent from the computing system to the OLT (at operation 445); and (6) providing the second network speed to the device (at operation 450).

In some examples, the OLT, which includes a service provider endpoint of a PON (e.g., PON 110a-110nof FIG. 1, or the like), may include a processing system and memory coupled to the processing system. In examples, the memory may include computer executable instructions that, when executed by the processing system, causes the OLT to perform operations such as operations 405-450 of FIG. 4. In examples, the processing system includes a virtual machine ("VM") that is instantiated within the processing system, that runs a first software application that causes the OLT to send the request for the IP address (e.g., at operation 405, or the like), and that runs a second software application that automatically causes the OLT to initiate the network speed test (e.g., at operations 420-450, or the like), either on a periodic basis, on a scheduled basis, or in response to data traffic to or from the OLT falling below a threshold level over a rolling period. In examples, the OLT may further include a dedicated chipset that is tasked with initiating the network speed test. Method 400 of FIG. 4 is otherwise similar, if not identical, to method 300 of FIG. 3.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100 and 200 of FIGS. 1 and 2, respectively (or components thereof), such methods may also be implemented using any suitable hardware (or software) implementation. Similarly, while each of the systems, examples, or embodiments 100 and 200 of FIGS. 1 and 2, respectively (or components thereof), can operate according to the methods 300, 400 (e.g., by executing instructions embodied on a computer readable medium), the systems, examples, or embodiments 100 and 200 of FIGS. 1 and 2 can each also operate according to other modes of operation and/or perform other suitable procedures.

### Exemplary System and Hardware Implementation

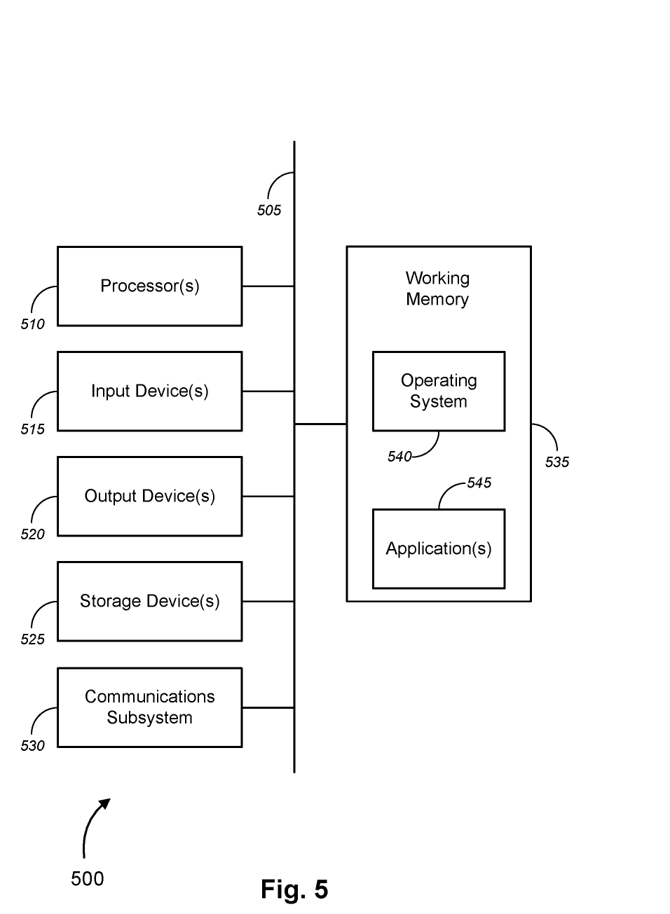

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., OLTs 105a-105n and 205, ONTs 115a-115oand 115p-115y, RGs 120a-120oand 120p-120y, broadband network gateways 130a-130n and 230, routers 145a-145k, 145l-145x, and 245a-245k, aggregation gateways 150a, 150b, and 250, servers 160 and 260, devices 175 and 275, and computing system(s) 280, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500 – which might represent an embodiment of the computer or hardware system (i.e., OLTs 105a-105n and 205, ONTs 115a-115o and 115p-115y, RGs 120a-120oand 120p-120y, broadband network gateways 130a-130nand 230, routers 145a-145k, 145l-145x, and 245a-245k, aggregation gateways 150a, 150b, and 250, servers 160 and 260, devices 175 and 275, and computing system(s) 280, etc.), described above with respect to FIGS. 1-4 – is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system located within a network of a service provider and from an optical line terminal ("OLT") of a passive optical network ("PON"), a request for an IP address;
assigning, by the computing system, a first IP address to the OLT, the first IP address being assigned from a list of IP addresses reserved for assignment to customer premises equipment ("CPE") to be connected to the network;
sending, by the computing system, an indication of the first IP address to the OLT;
sending, by the computing system, at least one test packet to the OLT over a path through the network, based on the first IP address, the path including network nodes in the network that transport data traffic over Layer 3 of the network;
receiving, by the computing system, a response to the at least one test packet from the OLT;
measuring, by the computing system, one or more network characteristics, based on the response; and
sending, by the computing system, the one or more network characteristics to a device.

2. The method of claim 1, wherein the computing system comprises at least one of a server, a router, a broadband network gateway, an aggregation gateway, or an orchestrator.

3. The method of claim 1, wherein the device includes one of a console of a network operations center ("NOC"), a technician device associated with a field technician, an agent device associated with an agent of the service provider, or a user device associated with a customer of the service provider who is associated with a CPE with which the OLT is communicatively coupled over the PON.

4. The method of claim 1, wherein the request for the IP address is a dynamic host configuration protocol ("DHCP") request, wherein the method further comprises:
authenticating, by the computing system, the OLT, in response to receiving the request for the IP address, wherein the IP address is a static IP address.

5. The method of claim 1, wherein the one or more network characteristics include at least one of latency, packet loss, jitter, bandwidth, network speed, connectivity, or network performance.

6. The method of claim 1, wherein the path through the network includes a plurality of alternative paths that are randomly selected using hashing of values in packet headers of data packets being transmitted between the computing system and the OLT, the plurality of alternative paths corresponding to a link aggregation group of the network.

7. The method of claim 1, wherein the OLT is configured to provide first optical data signals for transmission over the PON to a plurality of optical network terminals ("ONTs") located at customer premises, and configured to relay second optical data signals from the plurality of ONTs to the network or to convert the second optical data signals into electrical data signals for transmission to the network.

8. The method of claim 1, wherein measuring the one or more network characteristics comprises mapping a connectivity of the path through the network, by:
sending, by the computing system, an Internet control message protocol ("ICMP") packet to the OLT over the path;
receiving, by the computing system, a response from each router along the path that routes the ICMP packet to the OLT, the response from each router including an ICMP timestamp that includes a date and time of that router; and
generating at least one of a connectivity map or a connectivity report based on the ICMP timestamp for each router, the at least one of the connectivity map or the connectivity report indicating information regarding a number of routing hops along the path between the computing system and the OLT, information regarding each router along the path, information regarding whether each router is capable of transferring data, information regarding packet latency along each routing hop, and information regarding unresponsive or unreachable routers.

9. The method of claim 1, wherein measuring the one or more network characteristics comprises performing a network performance measurement over the path through the network, based on one of simple two-way active measurement protocol ("STAMP"), two-way active measurement protocol ("TWAMP"), a transmission control protocol ("TCP") -based echo service, or a user datagram protocol ("UDP") -based echo service.

10. The method of claim 1, wherein measuring the one or more network characteristics comprises implementing performance measurement and tuning, using a cross-platform tool, by performing one of:
measuring, by the computing system, a throughput of a payload that is sent over the path over TCP, and providing payload throughput measurement results; or
measuring, by the computing system, a throughput of a datagram that is sent over the path over UDP, and providing datagram throughput measurement results and packet loss results.

11. The method of claim 1, wherein measuring the one or more network characteristics comprises performing a network speed test, by:
sending, by the computing system, a plurality of first test packets to the OLT over the path over a first duration, measuring a first network speed at which the plurality of first test packets is sent from the computing system to the OLT, and providing the first network speed to the device; and
receiving, by the computing system, a plurality of second test packets from the OLT over the path over a second duration, measuring a second network speed at which the plurality of second test packets is sent from the OLT to the computing system, and providing the second network speed to the device.

12. A system, comprising:
a computing system located within a network of a service provider; and
memory coupled to the computing system, the memory comprising computer executable instructions that, when executed by the computing system, causes the computing system to perform operations comprising:
receiving a request for an IP address from an optical line terminal ("OLT") of a passive optical network ("PON");
assigning a first IP address to the OLT, the first IP address being assigned from a list of IP addresses reserved for assignment to customer premises equipment ("CPE") to be connected to the network;
sending an indication of the first IP address to the OLT;
sending at least one test packet to the OLT over a path through the network, based on the first IP address, the path including network nodes in the network that transport data traffic over Layer 3 of the network;
receiving a response to the at least one test packet from the OLT;
measuring one or more network characteristics, based on the response; and
sending the one or more network characteristics to a device.

13. The system of claim 12, wherein the computing system comprises at least one of a server, a router, a broadband network gateway, an aggregation gateway, or an orchestrator, wherein the device includes one of a console of a network operations center ("NOC"), a technician device associated with a field technician, an agent device associated with an agent of the service provider, or a user device associated with a customer of the service provider who is associated with a CPE with which the OLT is communicatively coupled over the PON.

14. The system of claim 12, wherein the one or more network characteristics include at least one of latency, packet loss, jitter, bandwidth, network speed, connectivity, or network performance.

15. The system of claim 12, wherein the request for the IP address is a dynamic host configuration protocol ("DHCP") request, wherein the operations further comprise:
authenticating the OLT, in response to receiving the request for the IP address, wherein the IP address is a static IP address.

16. The system of claim 12, wherein the path through the network includes a plurality of alternative paths that are randomly selected using hashing of values in packet headers of data packets being transmitted between the computing system and the OLT, the plurality of alternative paths corresponding to a link aggregation group of the network.

17. An optical line terminal ("OLT") of a passive optical network ("PON"), the OLT comprising:
a processing system; and
memory coupled to the processing system, the memory comprising computer executable instructions that, when executed by the processing system, causes the OLT to perform operations comprising:
sending a request for an Internet protocol ("IP") address to a broadband network gateway, via dynamic host configuration protocol ("DHCP");
receiving, from the broadband network gateway, an indication of an assignment of a first IP address for the OLT, the first IP address being assigned from a list of IP addresses reserved for assignment to customer premises equipment ("CPE") to be connected to a network of a service provider; and
exchanging data packets with a computing system that is located within the network of the service provider over a path through the network between the computing system and the OLT that is created based on the first IP address, the path including network nodes in the network that transport the data packets over Layer 3 of the network.

18. The OLT of claim 17, wherein the operations further comprise initiating a network speed test, by:
sending a plurality of first test packets to the computing system over the path over a first duration, measuring a first network speed at which the plurality of first test packets is sent from the OLT to the computing system, and providing the first network speed to a device; and
receiving a plurality of second test packets from the computing system over the path over a second duration, measuring a second network speed at which the plurality of second test packets is sent from the computing system to the OLT, and providing the second network speed to the device.

19. The OLT of claim 18, wherein the processing system includes a virtual machine ("VM") that is instantiated within the processing system, that runs a first software application that causes the OLT to send the request for the IP address, and that runs a second software application that automatically causes the OLT to initiate the network speed test either on a periodic basis, on a scheduled basis, or in response to data traffic to or from the OLT falling below a threshold level over a rolling period.

20. The OLT of claim 18, further comprising:
a dedicated chipset that is tasked with initiating the network speed test.
